(19) United States
(12) Patent Application Publication
(10) Pub. No.: US 2014/0058677 A1
(43) Pub. Date: Feb. 27, 2014

(54) METHOD FOR PROCESSING ELECTROMAGNETIC DATA

(71) Applicant: LEENDERT COMBEE, SANDVIKA (NO)

(72) Inventor: LEENDERT COMBEE, SANDVIKA (NO)

(73) Assignee: WESTERNGECO, L.L.C., HOUSTON, TX (US)

(21) Appl. No.: 13/592,884

(22) Filed: Aug. 23, 2012

(51) Int. Cl. G01V 3/18; G06F 19/00

(52) U.S. Cl. 702/7

(57) ABSTRACT

Methods and computing systems for processing electromagnetic data are disclosed. In one embodiment, a method is disclosed that includes performing a first controlled source electromagnetic survey at a selected area that includes a reservoir zone; performing additional controlled source electromagnetic surveys at the selected area after the first survey; and inverting measurements from the first survey and the additional surveys to identify at least one resistivity change in the reservoir zone after the first survey, wherein during the inversion, respective measured resistivity values from the first survey and respective measured resistivity values from the additional surveys are constrained to be constant, and correspond to one or more areas disposed in the selected area that are outside of the reservoir zone.

### BACKGROUND

Electromagnetic geophysical survey data, such as controlled source electromagnetic (“CSEM”) survey data are obtained by distributing a number of signal receivers or sensors above an area of the Earth's subsurface to be evaluated. The receivers or sensors are configured to detect one or more components of an electric and/or magnetic field imparted into the subsurface by actuation of an electromagnetic transmitter and altered by interaction of an electromagnetic field imparted into the subsurface by the transmitter.

The receivers or sensors may be nodal units placed on the water bottom for the duration of a marine CSEM survey or part thereof. The receivers or sensors may contain the necessary sensors (electrodes and magnetic field sensors), electronics, batteries, clocks, etc., to detect and record signals resulting from the imparted electromagnetic field. The sensors may also be part of a marine towed or ocean bottom cable system.

The imparted electromagnetic field may be generated by an electromagnetic transmitter such as a towed electric dipole. The towed dipole has two spaced apart electrodes across which an electric current is imparted. The foregoing results in a current emanating into the subsurface. The current imparted across the electrodes may be 1000 amperes or more (or in some cases, less), and the distance between the electrodes may be on the order of 300 meters (though larger or smaller distances may be used depending on the requirements of the survey and underlying geology of the survey area). The transmitter may be towed at close proximity to the water bottom over the survey area. The electromagnetic field produced by the transmitter is altered by the electrical resistivity of the subsurface, and the altered electromagnetic field or components thereof are recorded by the receivers. Once the survey or part thereof is completed, the receivers and recording equipment may be recovered and the recorded data retrieved for further analysis.

The processing of CSEM survey data may comprise two steps. First is conversion of the raw receiver sample values, e.g., voltages, into calibrated electromagnetic field amplitude and phase with respect to offset (distance between the transmitter and receiver at the time of signal acquisition). Second is inversion of the amplitude and phase data from all the receivers and transmitter positions at the time of transmitter actuation into a resistivity model of the subsurface. The latter process, inversion, may be a single-step operation whereby a subsurface model (of spatial distribution of resistivity in the subsurface) is generated, which by forward modelling of the receiver responses, produces modelled receiver responses that best match the measured receiver responses. The subsurface model may be constrained by a priori information concerning the structure of the subsurface formations and existence and location of potential hydrocarbon-bearing (reservoir) formations. The a priori information may be obtained, for example, from reflection seismic data.

If two separate CSEM surveys are acquired over the same survey area, the data for one survey may be somewhat different than the data from the other survey. The differences may be due to different transmitter and receiver positions between surveys, uncertainty in the foregoing positions as well as differences in receiver response and the like. The result is that when both data sets are processed separately, each will produce a somewhat different subsurface resistivity distribution, even though the data relate to one and the same real subsurface resistivity spatial distribution.

In the case of time lapse CSEM surveys, wherein a CSEM survey is made at a time after a prior CSEM survey, in a hydrocarbon bearing formation (“reservoir zone”) that has produced hydrocarbons therefrom, a change in subsurface electrical properties in the reservoir zone may have taken place. In such case, there may be a difference between resistivity distributions obtained from the first and subsequent CSEM surveys, however, such change in resistivity distribution should only be expected in reservoir zones.

Accordingly, there is a need for methods and computing systems that can employ more efficient and accurate electromagnetic survey data processing techniques, such as improved inversion and/or time-lapse processing techniques for electromagnetic data in varying configurations. Such methods and computing systems may complement or replace conventional methods and computing systems for processing electromagnetic survey data.

### SUMMARY

In accordance with some embodiments, a method is performed that includes: receiving at a computing system a first electromagnetic survey measurement set acquired at an area of interest at a first time, wherein the area of interest includes at least a first zone and a second zone, and the first electromagnetic survey measurement set includes a first resistivity value corresponding to the first zone, and a second resistivity value corresponding to the second zone; receiving at the computing system a second electromagnetic survey measurement set acquired at the area of interest after the first time, wherein the second electromagnetic survey measurement set includes a third resistivity value corresponding to the first zone, and a fourth resistivity value corresponding to the second zone; constraining the second and fourth resistivity values; and inverting the first and the second electromagnetic survey measurement sets to determine a change in resistivity in the first zone.

In accordance with some embodiments, a computing system is provided that includes at least one processor, at least one memory, and one or more programs stored in the at least one memory, wherein the one or more programs are configured to be executed by the one or more processors, the one or more programs including instructions for receiving at a computing system a first electromagnetic survey measurement set acquired at an area of interest at a first time, wherein the area of interest includes at least a first zone and a second zone, and the first electromagnetic survey measurement set includes a first resistivity value corresponding to the first zone, and a second resistivity value corresponding to the second zone; receiving at the computing system a second electromagnetic survey measurement set acquired at the area of interest after the first time, wherein the second electromagnetic survey measurement set includes a third resistivity value corresponding to the first zone, and a fourth resistivity value corresponding to the second zone; constraining the second and fourth resistivity values; and inverting the first and the second electromagnetic survey measurement sets to determine a change in resistivity in the first zone.

In accordance with some embodiments, a computer readable storage medium is provided, the medium having a set of one or more programs including instructions that when executed by a computing system cause the computing system to: receive at a computing system a first electromagnetic survey measurement set acquired at an area of interest at a first time, wherein the area of interest includes at least a first zone and a second zone, and the first electromagnetic survey measurement set includes a first resistivity value corresponding to the first zone, and a second resistivity value corresponding to the second zone; receive at the computing system a second electromagnetic survey measurement set acquired at the area of interest after the first time, wherein the second electromagnetic survey measurement set includes a third resistivity value corresponding to the first zone, and a fourth resistivity value corresponding to the second zone; constrain the second and fourth resistivity values; and invert the first and the second electromagnetic survey measurement sets to determine a change in resistivity in the first zone.

In accordance with some embodiments, a computing system is provided that includes at least one processor, at least one memory, and one or more programs stored in the at least one memory; and means for receiving at a computing system a first electromagnetic survey measurement set acquired at an area of interest at a first time, wherein the area of interest includes at least a first zone and a second zone, and the first electromagnetic survey measurement set includes a first resistivity value corresponding to the first zone, and a second resistivity value corresponding to the second zone; means for receiving at the computing system a second electromagnetic survey measurement set acquired at the area of interest after the first time, wherein the second electromagnetic survey measurement set includes a third resistivity value corresponding to the first zone, and a fourth resistivity value corresponding to the second zone; means for constraining the second and fourth resistivity values; and means for inverting the first and the second electromagnetic survey measurement sets to determine a change in resistivity in the first zone.

In accordance with some embodiments, an information processing apparatus for use in a computing system is provided, and includes means for receiving at a computing system a first electromagnetic survey measurement set acquired at an area of interest at a first time, wherein the area of interest includes at least a first zone and a second zone, and the first electromagnetic survey measurement set includes a first resistivity value corresponding to the first zone, and a second resistivity value corresponding to the second zone; means for receiving at the computing system a second electromagnetic survey measurement set acquired at the area of interest after the first time, wherein the second electromagnetic survey measurement set includes a third resistivity value corresponding to the first zone, and a fourth resistivity value corresponding to the second zone; means for constraining the second and fourth resistivity values; and means for inverting the first and the second electromagnetic survey measurement sets to determine a change in resistivity in the first zone.

In accordance with some embodiments, a method is performed that includes accepting as input first measured voltages from a first controlled source electromagnetic survey acquired at the area; accepting as input second measured voltages from a second controlled source electromagnetic survey acquired at the area after the first survey; and inverting the first measured voltages and the second measured voltages to determine at least one change in spatial distribution of resistivity in the reservoir zone, wherein a spatial distribution of resistivity outside the reservoir zone is constrained, and the at least one change in spatial distribution of resistivity occurred before the second survey.

In accordance with some embodiments, a computing system is provided that includes at least one processor, at least one non-transitory memory, and one or more programs stored in the at least one non-transitory memory, wherein the one or more programs are configured to be executed by the one or more processors, the one or more programs including instructions for accepting as input first measured voltages from a first controlled source electromagnetic survey acquired at the area; accepting as input second measured voltages from a second controlled source electromagnetic survey acquired at the area after the first survey; and inverting the first measured voltages and the second measured voltages to determine at least one change in spatial distribution of resistivity in the reservoir zone, wherein a spatial distribution of resistivity outside the reservoir zone is constrained, and the at least one change in spatial distribution of resistivity occurred before the second survey.

In accordance with some embodiments, a computer readable storage medium is provided, the medium having a set of one or more programs including instructions that when executed by a computing system cause the computing system to accept as input first measured voltages from a first controlled source electromagnetic survey acquired at the area; accept as input second measured voltages from a second controlled source electromagnetic survey acquired at the area after the first survey; and invert the first measured voltages and the second measured voltages to determine at least one change in spatial distribution of resistivity in the reservoir zone, wherein a spatial distribution of resistivity outside the reservoir zone is constrained, and the at least one change in spatial distribution of resistivity occurred before the second survey.

In accordance with some embodiments, a computing system is provided that includes at least one processor, at least one memory, and one or more programs stored in the at least one memory; and means for accepting as input first measured voltages from a first controlled source electromagnetic survey acquired at the area; means for accepting as input second measured voltages from a second controlled source electromagnetic survey acquired at the area after the first survey; and means for inverting the first measured voltages and the second measured voltages to determine at least one change in spatial distribution of resistivity in the reservoir zone, wherein a spatial distribution of resistivity outside the reservoir zone is constrained, and the at least one change in spatial distribution of resistivity occurred before the second survey.

In accordance with some embodiments, an information processing apparatus for use in a computing system is provided, and includes means for accepting as input first measured voltages from a first controlled source electromagnetic survey acquired at the area; means for accepting as input second measured voltages from a second controlled source electromagnetic survey acquired at the area after the first survey; and means for inverting the first measured voltages and the second measured voltages to determine at least one change in spatial distribution of resistivity in the reservoir zone, wherein a spatial distribution of resistivity outside the reservoir zone is constrained, and the at least one change in spatial distribution of resistivity occurred before the second survey.

In accordance with some embodiments, a method is performed that includes performing a first controlled source electromagnetic survey at a selected area that includes a reservoir zone; performing one or more subsequent controlled source electromagnetic surveys at the selected area after the first survey; and inverting measurements from the first survey and the one or more subsequent surveys to identify at least one resistivity change in the reservoir zone after the first survey, wherein during the inversion, one or more respective measured resistivity values from the first survey and one or more respective measured resistivity values from the one or more subsequent surveys: are constrained to be constant, and correspond to one or more areas disposed in the selected area that are outside of the reservoir zone.

In accordance with some embodiments, a computing system is provided that includes at least one processor, at least one memory, and one or more programs stored in the at least one memory, wherein the one or more programs are configured to be executed by the one or more processors, the one or more programs including instructions for performing a first controlled source electromagnetic survey at a selected area that includes a reservoir zone; performing one or more subsequent controlled source electromagnetic surveys at the selected area after the first survey; and inverting measurements from the first survey and the one or more subsequent surveys to identify at least one resistivity change in the reservoir zone after the first survey, wherein during the inversion, one or more respective measured resistivity values from the first survey and one or more respective measured resistivity values from the one or more subsequent surveys: are constrained to be constant, and correspond to one or more areas disposed in the selected area that are outside of the reservoir zone.

In accordance with some embodiments, a computer readable storage medium is provided, the medium having a set of one or more programs including instructions that when executed by a computing system cause the computing system to perform a first controlled source electromagnetic survey at a selected area that includes a reservoir zone; perform one or more subsequent controlled source electromagnetic surveys at the selected area after the first survey; and invert measurements from the first survey and the one or more subsequent surveys to identify at least one resistivity change in the reservoir zone after the first survey, wherein during the inversion, one or more respective measured resistivity values from the first survey and one or more respective measured resistivity values from the one or more subsequent surveys: are constrained to be constant, and correspond to one or more areas disposed in the selected area that are outside of the reservoir zone.

In accordance with some embodiments, a computing system is provided that includes at least one processor, at least one memory, and one or more programs stored in the at least one memory; and means for performing a first controlled source electromagnetic survey at a selected area that includes a reservoir zone; means for performing one or more subsequent controlled source electromagnetic surveys at the selected area after the first survey; and means for inverting measurements from the first survey and the one or more subsequent surveys to identify at least one resistivity change in the reservoir zone after the first survey, wherein during the inversion, one or more respective measured resistivity values from the first survey and one or more respective measured resistivity values from the one or more subsequent surveys: are constrained to be constant, and correspond to one or more areas disposed in the selected area that are outside of the reservoir zone.

In accordance with some embodiments, an information processing apparatus for use in a computing system is provided, and includes means for performing a first controlled source electromagnetic survey at a selected area that includes a reservoir zone; means for performing one or more subsequent controlled source electromagnetic surveys at the selected area after the first survey; and means for inverting measurements from the first survey and the one or more subsequent surveys to identify at least one resistivity change in the reservoir zone after the first survey, wherein during the inversion, one or more respective measured resistivity values from the first survey and one or more respective measured resistivity values from the one or more subsequent surveys: are constrained to be constant, and correspond to one or more areas disposed in the selected area that are outside of the reservoir zone.

In some embodiments, an aspect of the invention includes that a hydrocarbon reservoir is disposed in the first zone.

In some embodiments, an aspect of the invention includes that determining the change in resistivity in the first zone includes determining a spatial distribution of resistivity in the first zone.

In some embodiments, an aspect of the invention involves receiving at the computing system an initial structural model of the area of interest, wherein the initial structural model is based on a seismic survey.

In some embodiments, an aspect of the invention involves constraining one or more subareas of the area of interest based on the initial structural model before inverting the first and the second electromagnetic survey measurement sets.

In some embodiments, an aspect of the invention includes that constraining the second and fourth resistivity values includes setting the second and fourth resistivity values to a constant value.

In some embodiments, an aspect of the invention involves constraining changes in spatial distribution of resistivity in the first zone based on a physical limitation.

In some embodiments, an aspect of the invention includes that the physical limitation is selected from the group of metrics consisting of a volume of hydrocarbon extracted as compared with a pore volume of the first zone, resistivity of connate water in the first zone, and mineral composition of the first zone.

In some embodiments, an aspect of the invention involves receiving at the computing system a third electromagnetic survey measurement set acquired at the area of interest at a later time than the first electromagnetic survey measurement set, wherein the third electromagnetic survey measurement set includes a fifth resistivity value corresponding to the first zone and a sixth resistivity value corresponding to the second zone; and inverting the first and the third electromagnetic survey measurement sets to determine a change in resistivity in the first zone.

In some embodiments, an aspect of the invention involves inverting the second electromagnetic survey measurement set with the first and the third electromagnetic survey measurement sets to determine the change in resistivity in the first zone.

In some embodiments, an aspect of the invention involves constraining resistivity in the second zone by setting the second, fourth, and sixth resistivity values to a constant value before inverting the first, second, and third electromagnetic survey measurement sets.

In some embodiments, an aspect of the invention includes that constraining the spatial distribution of resistivity outside the reservoir zone includes setting respective measurements from the first and second controlled source electromagnetic surveys to a constant value.

In some embodiments, an aspect of the invention involves constraining changes in spatial distribution of resistivity in the at least one reservoir zone based on a physical limitation.

In some embodiments, an aspect of the invention includes that the physical limitation comprises at least one of volume of hydrocarbon extracted as compared with a pore volume of the at least one reservoir zone, resistivity of connate water in the at least one reservoir zone and mineral composition of the at least one reservoir zone.

Other aspects and advantages will be apparent from the description and claims which follow.

### BRIEF DESCRIPTION OF THE DRAWINGS

FIG. 1 shows one example of acquiring marine CSEM and marine seismic survey data in accordance with some embodiments.

FIG. 2 shows an example of acquiring marine CSEM survey data in accordance with some embodiments.

FIG. 3 shows an example of acquiring marine seismic data in accordance with some embodiments.

FIG. 4 shows another example of acquiring marine CSEM and marine seismic survey data in accordance with some embodiments.

FIG. 5 shows an alternative example transmitter that may be used to acquire marine CSEM data in accordance with some embodiments.

FIG. 6 shows an example computing system in accordance with some embodiments in accordance with some embodiments.

FIG. 7 illustrate a flow diagram of a survey data processing method in accordance with some embodiments.

FIGS. 8A, 8B and 8C show, respectively, an example reference time-lapse resistivity model, an example of CSEM data inversion results using known methods, and CSEM data inversion results generated in accordance with some embodiments.

FIGS. 9A, 9B, 10, and 11 illustrate flow diagrams of survey data processing methods in accordance with some embodiments.

### DESCRIPTION OF EMBODIMENTS

Reference will now be made in detail to embodiments, examples of which are illustrated in the accompanying drawings and figures. In the following detailed description, numerous specific details are set forth in order to provide a thorough understanding of the invention. However, it will be apparent to one of ordinary skill in the art that the invention may be practiced without these specific details. In other instances, well-known methods, procedures, components, circuits, and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first object or step could be termed a second object or step, and, similarly, a second object or step could be termed a first object or step, without departing from the scope of the invention. The first object or step, and the second object or step, are both objects or steps, respectively, but they are not to be considered the same object or step.

The terminology used in the description of the invention herein is for the purpose of describing particular embodiments only and is not intended to be limiting of the invention. As used in the description of the invention and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises” and/or “comprising,” when used in this specification, specify the presence of stated features, integers, steps, operations, elements and/or components, but do not preclude the presence or addition of one or more other features, integers, steps, operations, elements, components, and/or groups thereof.

As used herein, the term “if” may be construed to mean “when” or “upon” or “in response to determining” or “in response to detecting,” depending on the context.

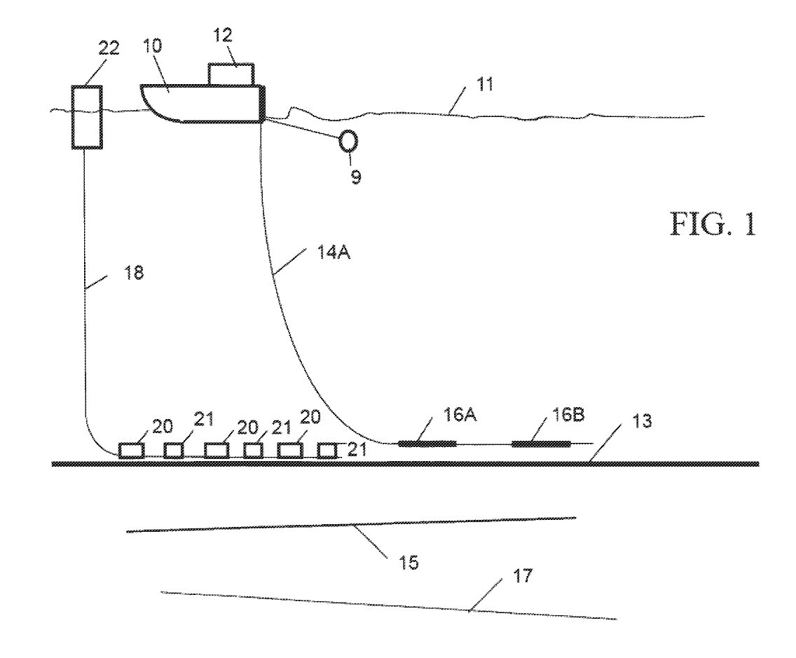

The following description of marine geophysical data acquisition is meant only to show example systems and procedures to obtain data that may be processed according to various aspects of the disclosure, and is not intended to limit the scope of such acquisition techniques. One example of a marine geophysical data acquisition system that may be used in various aspects of the invention includes a seismic energy source, seismic sensors, an electric and/or magnetic field source, and electric and/or magnetic field sensors. FIG. 1 shows one example of such a system. The data acquisition system includes a survey vessel 10 that moves in a predetermined pattern along the surface of a body of water 11 such as a lake or the ocean. The survey vessel 10 may include thereon seismic and electromagnetic (EM) source actuation, signal recording and navigation equipment, shown generally at 12 and referred to collectively herein as a “control/recording system.” The control/recording system 12 includes a controllable source of electric current (not shown separately) that is used to energize an electromagnetic transmitter, in the present example being a pair of electrodes 16A 16B towed in the water 11, preferably near the bottom 13 thereof, to impart an electromagnetic field into subsurface formations 15, 17 below the bottom 13 of the water 11. The control/recording system 12 typically includes instrumentation (not shown separately) to determine the geodetic position of the vessel 10 at any time, such as can be performed using global positioning system (GPS) receivers or the like.

The control/recording system 12 in the present example can include equipment to transfer signals between the recording system 12 and one or more recording buoys 22. The recording buoys 22 may be used to receive and store signals from each of a plurality of electromagnetic (EM) sensors 20 positioned at selected positions on the water bottom 13. The EM sensors 20 may be disposed along a receiver cable 18. The receiver cable 18 may be of a type ordinarily used in connection with seismic sensors deployed on the water bottom known in the art as “ocean bottom cables.” While the present example shows sensors 20 disposed on the seabed connected to a cable 18 with a surface buoy 22, in other examples the sensors could also be separate elements placed on the seabed by any suitable means, such as remotely operated vehicles (ROVs) or by a autonomous drop and recovery system. The sensors 20 may also be towed sensors embedded in a marine towed cable, either from the vessel 10 or another vessel (not shown). The EM sensors 20 are configured to detect electric and/or magnetic field components that result from electromagnetic fields induced in the Earth's subsurface by electric current passing through the transmitter (e.g., electrodes 16A, 16B). As explained above, the EM sensors 20 may also be individual “nodal” recording devices. See, for example, U.S. Pat. No. 6,842,006 issued to Conti et al., or may be towed sensors arranged on one or more streamers towed by the vessel 10 or another vessel (not shown). See, e.g., U.S. Pat. No. 8,115,491 issued to Alumbaugh et al.

Referring again to the example of FIG. 1, the recording buoys 22 may include telemetry devices (not shown separately) to transmit the detected signals to the recording system 12 on the vessel 10, and/or may store the signals locally for later interrogation by the control/recording system 12 or by another interrogation device such as a processor. Alternatively, the sensors' signals may be locally and autonomously recorded, and such recordings may be retrieved at the end of the survey.

The current source (not shown separately) in the control/recording system 12 may be coupled to the electrodes 16A, 16B by a cable 14A. The cable 14A may be configured such that the electrodes 16A, 16B can be towed essentially horizontally near the water bottom 13 as shown in FIG. 1. In the present embodiment, the electrodes 16A, 16B may be spaced apart by about 300 meters, and can be energized such that about 1000 Amperes of current flows through the electrodes 16A, 16B. The foregoing spacing and current produces an equivalent source moment to that generated in typical electromagnetic survey practice known in the art using a 100 meter long transmitter dipole, and using 3000 Amperes current. In either case the source moment can be about 3×10⁵ Ampere-meters. The electric current used to energize the transmitter electrodes 16A, 16B can be direct current (DC) that is switched off at a signal recording time index equal to zero. It should be understood, however, that switching DC off is only one implementation of electric current control that is operable to induce transient electromagnetic effects. In other embodiments, the electric current may be switched on, may be switched from one polarity to the other (bipolar switching), or may be switched in a pseudo-random binary sequence (PRBS) or any hybrid derivative of such switching sequences. See, for example, Duncan, P. M., Hwang, A., Edwards, R. N., Bailey, R. C., and Garland, G. D., 1980, “The development and applications of a wide band electromagnetic sounding system using pseudo-noise source,” Geophysics, 45, 1276-1296 for a description of PBRS switching. In other examples, the current may be single frequency or multiple frequency alternating current (AC).

In the present example, as the current through the transmitter electrodes 16A, 16B is switched, a time-indexed recording of electric and/or magnetic fields detected by the various EM sensors 20 is made, either in the recording buoys 22 and/or in the control/recording system 12, depending on the particular configuration of recording and/or telemetry equipment in the recording buoys 22 and in the control/recording system 12.

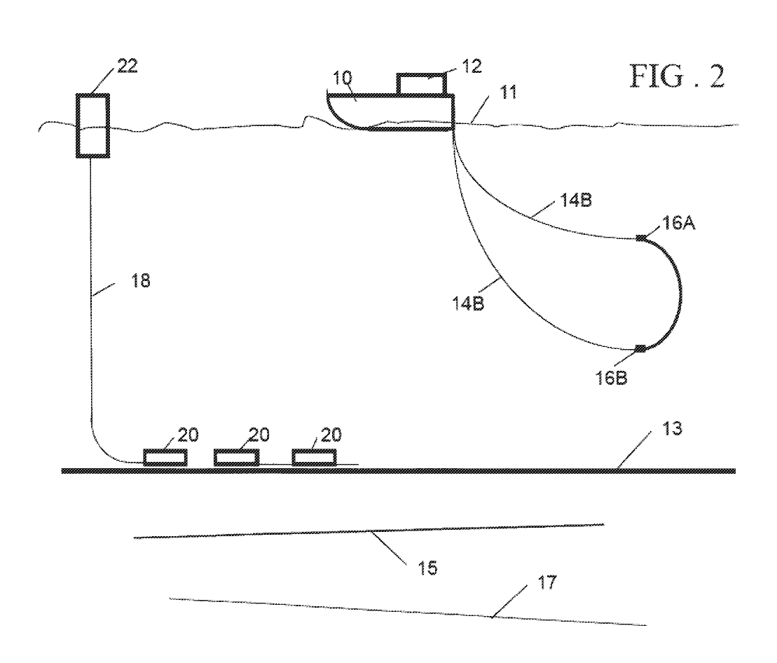

FIG. 2 shows another implementation of EM signal generation and recording, in which the transmitter electrodes 16A, 16B are arranged such that they are oriented substantially vertically along a cable 14B configured to cause the electrodes 16A, 16B to be oriented substantially vertically. Energizing the electrodes 16A, 16B, detecting and recording signals is performed substantially as explained above with reference to FIG. 1. Some implementations may include both the cable 14B as shown in FIG. 2, as well as a cable such as the cable 14A shown in FIG. 1 to be able to acquire signals induced by both vertical electric polarization as well as horizontal electric polarization. Still other embodiments may include rotation of the electric field imparted into the subsurface by applying selected fractions of the electric current to both the vertical electrode dipole (cable 14B in FIG. 2) and the horizontal electric dipole (cable 14A in FIG. 1).

Referring once again to FIG. 1 in the present example, the vessel 10 or another vessel (not shown) may also tow a seismic energy source, shown generally at 9. The seismic energy source 9 is typically an array of air guns, but can be any other type of seismic energy source known in the art. The control/recording system 12 can include control circuits (not shown separately) for actuating the seismic source 9 at selected times, and recording circuits (not shown separately) for recording signals produced by seismic sensors. In the present example, the sensor cable 18 may also include seismic sensors 21. The seismic sensors 21 are preferably “four component” sensors, which as is known in the art include three orthogonal geophones or similar motion or acceleration sensors collocated with a hydrophone or similar pressure responsive sensor. Four component ocean bottom cable seismic sensors are well known in the art. See, for example, U.S. Pat. No. 6,021,090 issued to Gaiser et al.

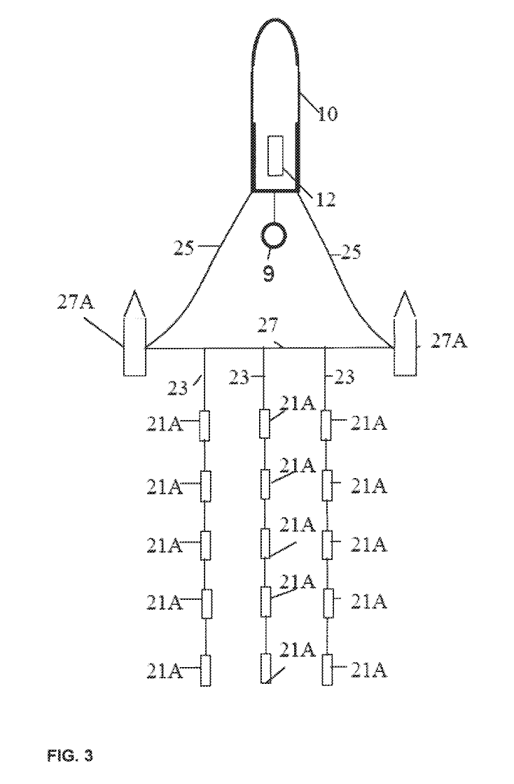

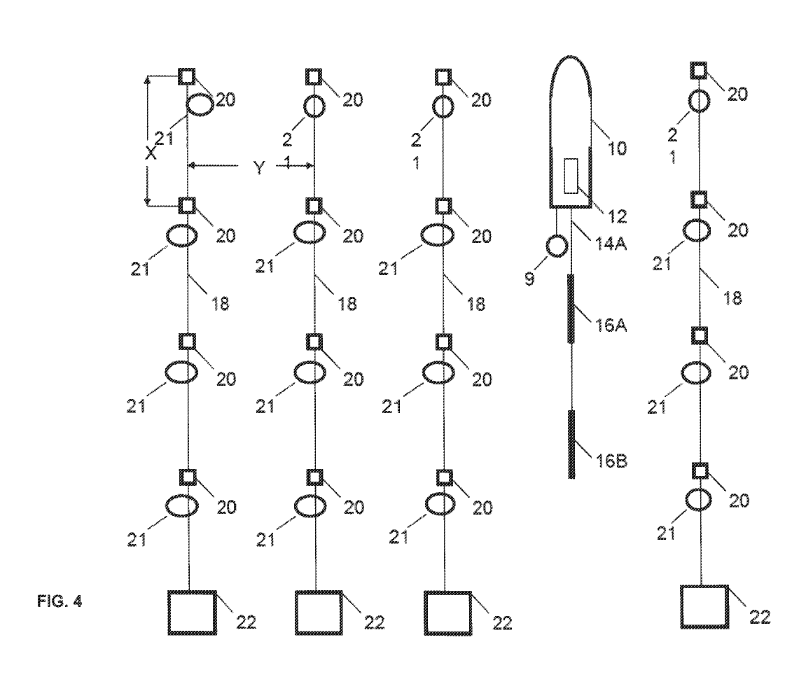

FIG. 4 shows a typical arrangement of ocean bottom-deployed sensor cables 18 having EM sensors 20 and seismic sensors 21 at spaced-apart positions thereon for acquiring a three dimensional survey according to the invention. Each cable 18 may be positioned essentially along a line in a selected direction above a portion of the Earth's sub surface that is to be surveyed. The longitudinal distance between the EM sensors 20 and seismic sensors 21 on each cable 18 is represented by x in FIG. 4, and in the present embodiment may be on the order of 100 to 200 meters. For practical purposes the individual sensors 20 and 21 may be co-located. Each cable 18 is shown as terminated in a corresponding recording buoy 22, as explained above with reference to FIG. 3A. The cables 18 are preferably positioned substantially parallel to each other, and are separated by a lateral spacing shown by y. In some embodiments, y is substantially equal to x, and is on the order of about 100 to 500 meters. In some embodiments, the EM sensors 20 and seismic sensors 21 may be randomly distributed, that is, respective spacing of x and/or y between adjacent sensors may be random. In some embodiments, y and x spacing may vary so that sensor spacing between adjacent sensors 20 and 21 can be configured according to other suitable distributions given the subsurface characteristics as those with skill in the art will appreciate. Additionally, sensors 20 and 21 may also be autonomous recording devices without cabled connection to the respective recording buoys. It is only necessary in such embodiments to know the geodetic position of each EM sensor and each seismic sensor, and that the average separation is as described above. In some circumstances, and depending on the characteristics of the subsurface, random spacing may improve signal to noise ratio in the results of an electromagnetic survey. Furthermore, in some embodiments, distances between seismic sensors 21 may be on the order of between 12.5 meters and 50 meters; in some embodiments distances between EM sensors may be up to three kilometres or more. For a two-dimensional survey, only one such streamer is required, and the vessel 10 may pass only once along this line (though varying embodiments need not be limited as such).

In some embodiments, seismic survey data that may be used to provide a priori subsurface structure and formation composition analysis may also be acquired separately using surface acquisition equipment, as shown in FIG. 3. As illustrated in the example acquisition system shown in FIG. 3, an acquisition system may include the survey vessel 10 and recording system 12 thereon. The vessel 10 may tow one or more seismic energy sources 9 or arrays of such sources in the water. The vessel 10 tows a plurality of sensor streamers 23 each having a plurality of spaced apart seismic sensors 21A thereon. The streamers 23 may be maintained in lateral positions with respect to each other by towing equipment that includes lead in cables 25 coupled to the vessel 10. The lead in cables 25 are laterally separated by the action in the water of paravanes 27A coupled to the distal ends of the lead-in cables 25. The paravanes 27A are held at a selected lateral spacing by a spreader cable 27. The streamers 23 are affixed to the spreader cable 27. The seismic sensors 21A may include hydrophones or other pressure or pressure gradient sensors, or may be pressure-responsive sensors in combination with various forms of particle motion sensors, such as geophones or accelerometers. Other examples may include more or fewer such streamers 23. Accordingly, the configuration of seismic data acquisition system described above is not a limit on the scope of the invention.

Referring once again to FIG. 1, in conducting a CSEM survey, the vessel 10 moves along the surface of the water 11, and periodically the control/recording system 12 energizes the transmitter electrodes 16A, 16B as explained above. The transmitter electrodes 16A, 16B are energized continuously or at selected times such that the vessel 10 moves a selected distance, for example, about 10-100 meters between successive activations or energizations of the transmitter electrodes 16A, 16B. Signals detected by the various EM sensors 20 are recorded with respect to time, and such time is indexed related to the time of energizing the electrodes 16A, 16B.

The vessel 10 is shown moving substantially parallel to the sensor cables 18. In other examples, after the vessel 10 moves in a direction parallel to the sensor cables 18, substantially above the position of each cable 18 on the water bottom 13, then the vessel 10 may move transversely to the sensor cables 18, along sail lines substantially above the position of corresponding EM sensors 20 and seismic sensors 21 on each cable 18 on the water bottom 13.

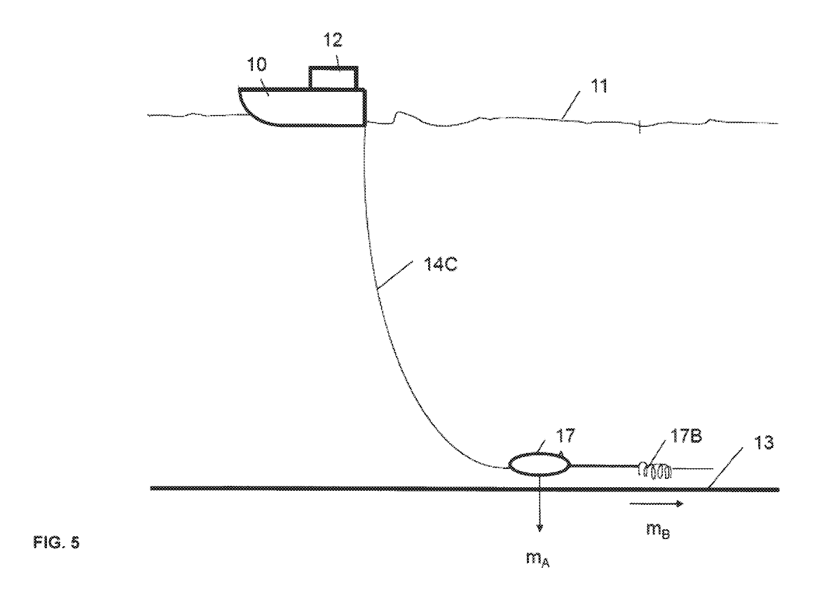

FIG. 5 shows other examples of EM transmitters. Current from the control/recording system 12 may be passed through a wire loop or coil 17 coupled to the cable 14C and arranged as a vertical magnetic dipole with moment indicated by ma. In substitution of, or in addition thereto, a wire coil or loop 17B may be coupled to the cable 14C and may be configured as a horizontal magnetic dipole with moment shown by mb.

The foregoing examples of acquisition systems may be used to perform time lapse CSEM surveying. The EM transmitters and sensors may be used to determine sensor response at various transmitter to receiver distances (offsets) above the area of the subsurface to be surveyed, which may include one or more hydrocarbon bearing (reservoir) formations, e.g., 17 in FIG. 1. A priori structural and formation composition below the water bottom (13 in FIG. 1) may be determined using the seismic source and seismic sensors, through interpretation procedures known in the art. At selected times, one or more subsequent CSEM surveys may be performed over substantially the same area of the subsurface to be evaluated. It is within the scope of the invention to repeat the seismic survey at selected times. Seismic acquisition and interpretation is not limited to obtaining a priori structure and composition data.

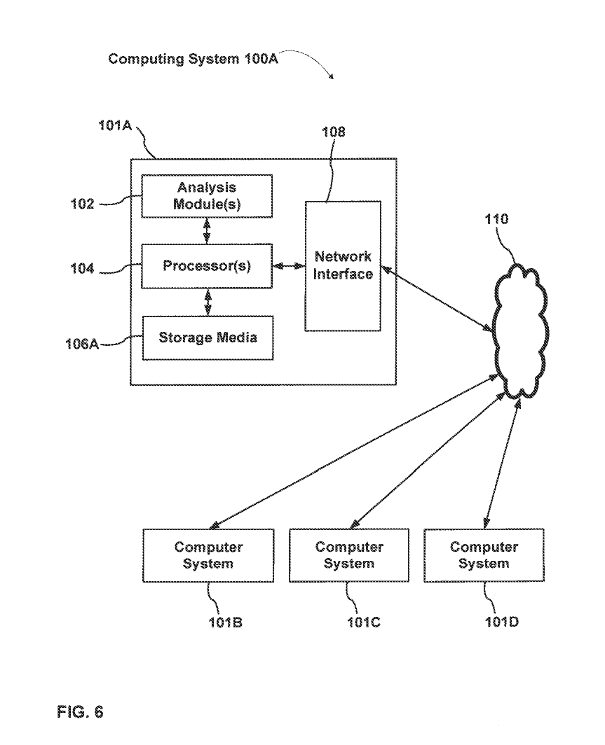

FIG. 6 depicts an example computing system 100 in accordance with some examples. The computing system 100 can be an individual computer system 101A or an arrangement of distributed computer systems. The individual computer system 101A includes one or more analysis modules 102 that are configured to perform various tasks according to some examples, such as methods 700, 900, 1000, and/or 1100. To perform these various tasks, analysis module 102 executes independently, or in coordination with, one or more processors 104, which is (or are) connected to one or more storage media 106, which may include one or more non-transitory storage memories. The processor(s) 104 is (or are) also connected to a network interface 108 to allow the computer system 101A to communicate over a data network 110 with one or more additional computer systems and/or computing systems, such as 101B, 101C, and/or 101D (note that computer systems 101B, 101C and/or 101D may or may not share the same architecture as computer system 101A, and may be located in different physical locations, e.g. computer systems 101A and 101B may be on a ship underway on the ocean, while in communication with one or more computer systems such as 101C and/or 101D that are located in one or more data centers on shore, other ships, and/or located in varying countries on different continents).

A processor can include a microprocessor, microcontroller, processor module or subsystem, programmable integrated circuit, programmable gate array, or another control or computing device.

The storage media 106 can be implemented as one or more computer-readable or machine-readable storage media. Note that while in the example embodiment of FIG. 6 storage media 106 is depicted as within computer system 101A, in some embodiments, storage media 106 may be distributed within and/or across multiple internal and/or external enclosures of computing system 101A and/or additional computing systems. Storage media 106 may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs), BluRays, or other optical media; or other types of storage devices. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) capable of being configured to be non-transitory. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

It should be appreciated that the computing system 100 is only one example of a computing system, and that the computing system 100 may have more or fewer components than shown, may combine additional components not shown in the example of FIG. 6, and/or computing system 100 may have a different configuration or arrangement of the components depicted in FIG. 6. The various components shown in FIG. 6 may be implemented in hardware, software, or a combination of both hardware and software, including one or more signal processing and/or application specific integrated circuits.

Further, the steps in the processing methods described herein may be implemented by running one or more functional modules in information processing apparatus such as general purpose processors or application specific chips, such as ASICs, FPGAs, PLDs, or other appropriate devices. These modules, combinations of these modules, and/or their combination with general hardware are all included within the scope of protection of the invention.

Time lapse CSEM survey and inversion methods according to some disclosed embodiments herein are based using a CSEM survey data set as part of the input of the processing/inversion of the data at a plurality of steps (instead of only a single corresponding data set); in some embodiments, the CSEM survey data set is used as part of the input for the processing/inversion of the data at every step. In some embodiments, a single time-lapse resistivity subsurface model may be inverted for varying combinations of the following conditions:
resistivity values of non-reservoir zones are constrained for time-lapse CSEM data sets.
resistivity values for the reservoir zone are allowed to vary for time lapse-CSEM data sets
The change in resistivity values for the reservoir zone may be constrained based on physical limitations and/or a priori information, which in some embodiments, may be derived from for example time-lapse seismic data. Physical limitations may include, for example, a volume of hydrocarbon extracted as compared with a pore volume of the reservoir zone(s), resistivity of connate water in the reservoir zone(s), mineral composition of the reservoir zone(s).

The inversion of a CSEM data set can be described as follows:

Minimize U=∥δm∥²+∥P(m−m*)∥²+1/μ∥W(d−F(m))∥² (Eq. 1)

where U represents an objective function whose value is to be minimized. The first term on the right hand side of Eq. (1) describes the model roughness. The second term represents the difference between the estimated subsurface model and an a-priori subsurface model. The third term describes misfit between the recorded EM sensor data and forward modelled EM sensor data. Additional information about δ, Δ, P, W, and μ is provided below.

In accordance with some embodiments, the above definition is extended to include a mechanism for accounting for time-lapse differences, as follows:
Minimize the objective function U wherein:

U=∥δm∥²+∥P(m−m*)∥²+∥Δmᵣ∥²+1/μ1/NΣ∥Wᵢ(dᵢ−F([mₙᵣ;mᵣᵢ])∥² (Eq. 2)

where m=[mₙᵣ; mᵣ]=[mₙᵣ; mᵣ₁; mₙ₂; . . . ] is a vector that contains all non-reservoir model parameters (mₙᵣ) and the series of reservoir model parameters mᵣ₁, mₙ₂, etc. Each of these parameters pertains to a successively recorded CSEM data set. The number of data sets in Eq. 2 is equal to N. Δmᵣ constrains the change in reservoir model parameters from one CSEM data set to the next CSEM data set. The final term in Eq. 2 is the misfit between the recorded CSEM data for the i-th data set and the forward modelled CSEM data for the i-th set of model parameters and is combined (summed) over all CSEM datasets (or in some embodiments, a plurality of CSEM datasets).

As explained above, an initial model may be based on, for example surface reflection seismic data, creating subsurface subvolumes (“cells”) each having constant electromagnetic properties (resistivity) and identifying potential boundaries between resistivity zones. Volumes, cells and boundaries may be constructed automatically by, e.g., seismic interpretation software known in the art.

In Eq. (2), the inversion parameters such as Δ, P, W in Eq. (2) are known in the art of CSEM inversion as they are part of inversion processes known in the art and are also used in time-lapse CSEM surveys. W controls the weight, i.e., which measurements (or parts thereof) contribute more to the model validation then others. Such measurements or parts could be, for example, certain frequencies, offset ranges, or those source and sensor positions that are closer to the reservoir rather than those further away. δ controls the model roughness, i.e., the rapidness and magnitude of variations in the subsurface properties that can be allowed for. For example, it is more likely to have a 200 m subsurface layer with a close to constant resistivity rather than one where the resistivity varies by a factor of 100 every 1 meter. ∥δ m∥ favors a model with a lower model roughness. The value of δ may be in part derived from seismic data as the seismic structure will determine the structural complexity and thereby roughness; P is similar to δ and favors models that are close to the expected model. For example, a non-reservoir zone will typically have a resistivity of a few ohm-m. The function of P is to favor models that have a non-reservoir resistivity estimate close to a few ohm-m instead of 100 s of ohm-m—which, through experience, has been determined not to be a realistic representation of subsurface resistivity distribution. Δ mᵣ describes the changes in the reservoir zone. A will depend on the time between successive CSEM surveys; the larger the time and/or amount of reservoir production, the smaller the value of Δ. μ controls the relative weight between model fit and model characteristics.

The values/functions δ, Δ, P, W, μ may be set on a case by case basis as they depend on the subsurface characteristics, complexity of the subsurface structure, time and overlap between successive CSEM surveys, etc.

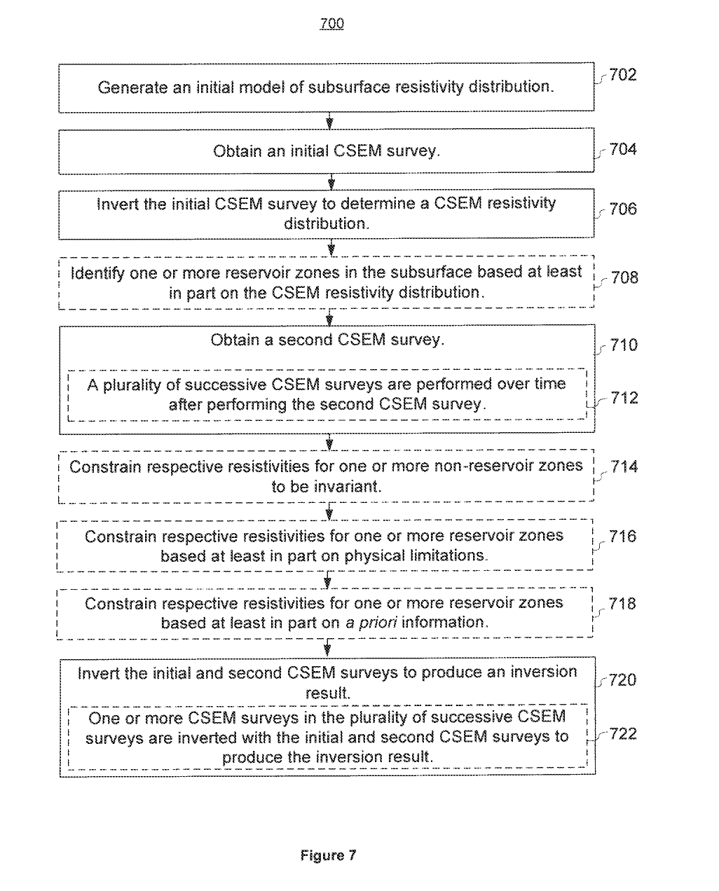

Attention is now directed to FIG. 7, which is a flow diagram illustrating an electromagnetic data processing method 700 in accordance with some embodiments. Some operations in method 700 may be combined and/or the order of some operations may be changed. Further, some operations in method 700 may be combined with aspects of the example methods 900, 1000, and/or 1100, and/or the order of some operations in method 700 may be changed to account for incorporation of aspects of the example methods 900, 1000, and/or 1100.

It is important to recognize that geologic interpretations, models and/or other interpretation aids may be refined in an iterative fashion; this concept is applicable to methods 700, 900, 1000, and/or 1100 as discussed herein. This can include use of feedback loops executed on an algorithmic basis, such as at a computing device (e.g., computing system 100, FIG. 6), and/or through manual control by a user who may make determinations regarding whether a given step, action, template, model, or set of curves has become sufficiently accurate for the evaluation of the subsurface three-dimensional geologic formation under consideration.

The method 700 is performed at a computing device (e.g., computing system 100, FIG. 1).

Method 700 includes generating an initial model of subsurface resistivity distribution (702). For example, an initial model of the subsurface may be obtained, for example, by using reflection seismic data obtained as explained above and interpreted for subsurface structure and formation composition to generate the initial model.

Method 700 includes that an initial CSEM survey may be obtained (704), for example, as explained with reference to FIGS. 1-5.

Method 700 includes inverting the initial CSEM survey to determine a CSEM resistivity distribution, i.e., a spatial distribution of resistivity in the subsurface area of interest (706). In some embodiments, the initial CSEM survey is inverted with the initial model as a constraint. In some embodiments, the initial CSEM survey is inverted alone.

In some embodiments, the CSEM resistivity distribution may be used to identify one or more reservoir zones in the subsurface (708). In varying embodiments, identification of the one or more reservoir zones may be based at least in part on the CSEM resistivity distribution, as other materials and information may be used in conjunction with the CSEM resistivity distribution to identify reservoir zone(s).

Method 700 includes that a second CSEM survey is obtained for the same subsurface area of interest (710). In some embodiments a plurality of successive CSEM surveys are performed over time after performing the second CSEM survey (712).

In some embodiments, before performing a subsequent inversion, respective resistivities for one or more non-reservoir zones are constrained to be invariant during the inversion (714). In some embodiments, the inversion result from the first and one or more subsequent CSEM survey(s) may be constrained so that resistivity is invariant in any zones other than the identified reservoir zones(s).

In some embodiments, before performing a subsequent inversion, respective resistivities for one or more reservoir zones are constrained based at least in part on physical limitations (716). In some embodiments, before performing a subsequent inversion, respective resistivities for one or more reservoir zones are constrained based at least in part on a priori information, such as seismic survey data (718).

Method 700 includes that the initial and second CSEM surveys are inverted to produce an inversion result (720), i.e., inversion of the initial and second CSEM surveys produce a time-lapse CSEM survey of one or more of the identified reservoir zones(s). In some embodiments, one or more CSEM surveys in the plurality of successive CSEM surveys are inverted with the initial and second CSEM surveys to produce the inversion result (722), i.e., inversion of the initial, second, and any additional CSEM surveys produce an updated time-lapse CSEM survey of one or more of the identified reservoir zones(s).

In some embodiments, each CSEM survey of the subsurface area of interest are inverted (e.g., in an example where there are n CSEM surveys of the subsurface area of interest, each of the n CSEM surveys of the subsurface area of interest are inverted). In some embodiments, the inversion of the plurality of CSEM surveys is performed using the foregoing resistivity constraints and by minimizing the objective function defined in equation (2) shown above.

In varying embodiments, the inversion can be joint inversion, simultaneous inversion, concurrent inversion, synchronized inversion, or other forms of coordinated inversion, depending on any or all of the following considerations: the architecture of the computing system used for inversion, the operating system architecture, the programming language(s) used, application programming interface(s), etc. Additionally, those with skill in the art will appreciate that the inversion can be carried out on multiple processor and/or multiple core computing systems, as well as on individual single processor computing systems by using threading, context switches between multiple processing routines that are operating on one or more domains to be jointly inverted, varying forms of interprocess control, communication, and/or coordination, etc.

Changes in resistivity distribution in the reservoir zone(s) may be identified from the inversion result at 716 or 718. Changes in resistivity distribution identified from inversion of any subsequent CSEM survey(s) may be constrained as further explained below. In the present example, the initial CSEM survey and the second (and/or additional) CSEM surveys may be inverted jointly using the constraints described herein.

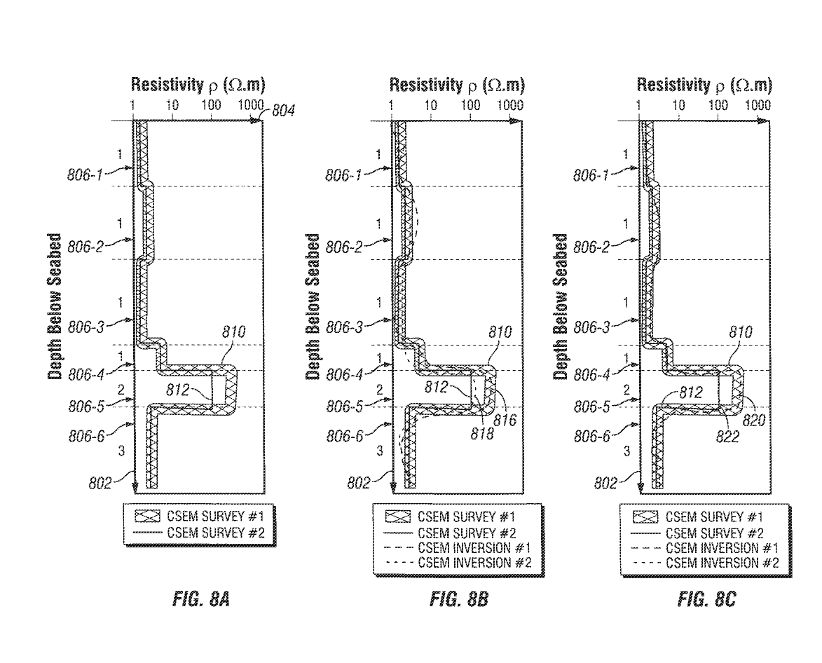

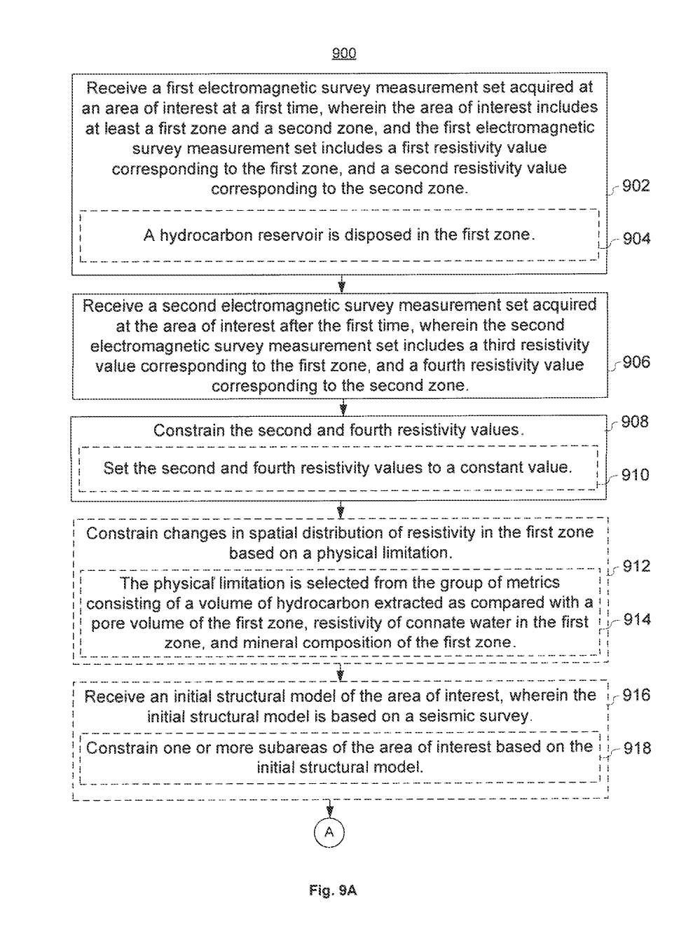

Attention is now directed to FIGS. 8A-8C, which compares simulated results of a CSEM data processing method in accordance with some embodiments with a theoretically correct set of resistivity values and a previously known method for a selected initial model of subsurface formations. In FIG. 8A, various subsurface geologic structures (layers, strata, etc.) are identified as a function of depth below the surface. Vertical axis 802 indicates depth, with lower areas of the chart indicating deeper structures below the surface. Horizontal axis 804 represents resistivity on a scale from 1 ohm-m (electrically conductive) to 1000 ohm-m (electrically resistive). Structures 806-1, 806-2, 806-3, 806-4, and 806-6 represent formations whose respective resistivities do not change substantially over time. Structure 806-5 represents a hydrocarbon bearing (reservoir) layer or zone.

Hydrocarbon zones are ordinarily resistive, but become more conductive as oil and/or gas are removed from the reservoir (e.g., as hydrocarbons are displaced by water in an active water drive reservoir formation). Curve 810 represents an assumed true model of resistivity in the subsurface at the time of a first CSEM survey and curve 812 represents an assumed true model of resistivity in the subsurface at the time of a second CSEM survey performed after the first survey. There may be differences between the resistivity at the time of the first survey and at the time of the second survey only in the reservoir zone structure 806-5 as indicated by the curves 810 and 812.

In FIG. 8B simulated data recorded in each of two time-separated CSEM data sets made using formation resistivities as explained with reference to FIG. 8A are each inverted separately using techniques known in the art. The results, shown by curves 816 and 818, respectively, for the first and second CSEM surveys, shows that outside the reservoir zone the inverted resistivities do not match exactly. Thus the validity of the results in structure 806-5, may be subject to question. As a result it may be uncertain how much of the difference between curves 816 and 818 within the reservoir zone structure 806-5 is due to uncertainties and/or errors in the measurements in one or both of the CSEM surveys and their respective inversion results and how much of the difference between curves 816 and 818 represents true change in reservoir electrical properties.

FIG. 8C shows results of inversion of the simulated CSEM data from the two simulated data sets preformed according to a method according to some embodiments, such as method 700 described above with reference to FIG. 7 for the first CESM survey, shown by curve 820 and for the second CSEM survey shown by curve 822. The resistivities and layer thicknesses outside the reservoir zone structure 806-5, as explained with reference to FIG. 7, are constrained to be the same for both simulated data sets (e.g., in structures 806-1, 806-2, 806-3, 806-4, and 806-6), thereby improving the consistency of the results between surveys and reducing uncertainty of the results determined for the reservoir zone structure 806-5. Using an example method as described herein may result in all data inversions being consistent with each other and the underlying model and its physical constraints.

CSEM data inversion algorithms known in the art do not have means to jointly invert multiple electromagnetic datasets for a model where the properties of certain zones are allowed to vary and with the type of constraints imposed herein. Inversion algorithms known in the art are based on a single model that derives from a single data set as opposed to multiple linked models derived from multiple linked data sets.

In the case where a subsequent CSEM data set is acquired without any known change in the reservoir structure (e.g., as described previously), the present example inversion method would invert both data sets jointly for a model in which the changes in the subsurface model for the reservoir zone(s) are set to zero, i.e., Δ-> infinity. In this respect the present example method presents a unified inversion approach that is consistent with any input data and any physical subsurface model, including those in which no change in subsurface properties has taken place. Minimizing the objective function, U, may be performed using any one of a number of iterative approaches well known in the art.

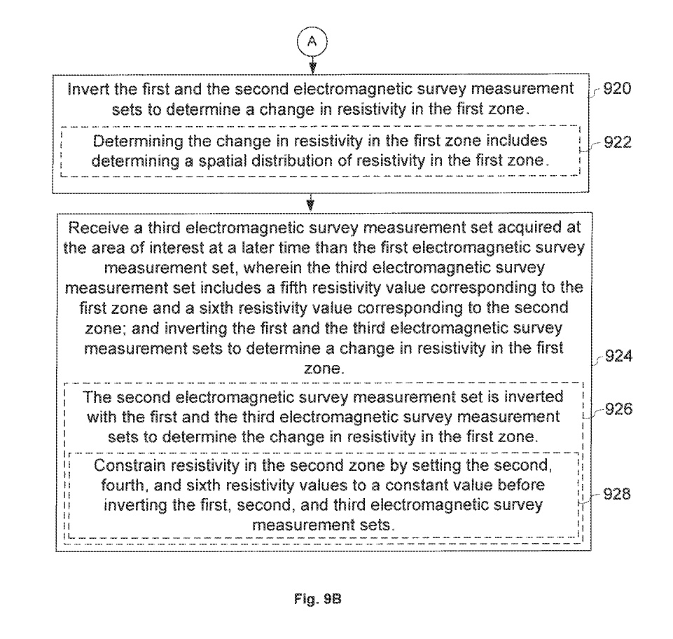

Attention is now directed to FIGS. 9A-9B, which are flow diagrams illustrating an electromagnetic data processing method 900 in accordance with some embodiments. Some operations in method 900 may be combined and/or the order of some operations may be changed. Further, some operations in method 900 may be combined with aspects of the example methods 700, 1000, and/or 1100, and/or the order of some operations in method 900 may be changed to account for incorporation of aspects of the example methods 700, 1000, and/or 1100.

The method 900 is performed at a computing device (e.g., computing system 100, FIG. 1).

Method 900 includes receiving (902) at a computing system a first electromagnetic survey measurement set acquired at an area of interest at a first time. The area of interest includes at least a first zone and a second zone, and the first electromagnetic survey measurement set includes a first resistivity value corresponding to the first zone, and a second resistivity value corresponding to the second zone, i.e., electromagnetic survey measurements are collected for different zones in the area of interest. (see e.g., FIG. 7, method 700 where an initial CSEM survey is obtained 704).

In some embodiments, a hydrocarbon reservoir is disposed in the first zone (904).

Method 900 includes receiving (906) at the computing system a second electromagnetic survey measurement set acquired at the area of interest after the first time, wherein the second electromagnetic survey measurement set includes a third resistivity value corresponding to the first zone, and a fourth resistivity value corresponding to the second zone. (see e.g., FIG. 7, method 700 where a second CSEM survey is obtained 710).

Method 900 includes constraining (908) the second and fourth resistivity values, e.g., the resistivity values corresponding to the second zone are constrained. (see e.g., FIG. 7, method 700 where respective resistivities for one or more non-reservoir zones are constrained 714) In some embodiments, constraining the second and fourth resistivity values includes setting the second and fourth resistivity values to a constant value (910) (see e.g., FIG. 7, method 700 where respective resistivities for one or more non-reservoir zones are constrained 714 to be invariant).

In some embodiments, method 900 includes constraining (912) changes in spatial distribution of resistivity in the first zone based on a physical limitation. In further embodiments, this physical limitation is selected from the group of metrics consisting of a volume of hydrocarbon extracted as compared with a pore volume of the first zone, resistivity of connate water in the first zone, and mineral composition of the first zone (914). (see e.g., FIG. 7, method 700 where respective resistivities for one or more reservoir zones are constrained 716 based at least in part on a physical limitation)

In some embodiments, method 900 includes receiving at the computing system an initial structural model of the area of interest, wherein the initial structural model is based on a seismic survey (916). In further embodiments, method 900 includes constraining one or more subareas of the area of interest based on the initial structural model before inverting the first and the second electromagnetic survey measurement sets (918) (see e.g., FIG. 7, method 700 where respective resistivities for one or more reservoir zones are constrained 718 based at least in part on a priori information, such as a seismic survey)

Method 900 also includes inverting (920) the first and the second electromagnetic survey measurement sets to determine a change in resistivity in the first zone (see e.g., FIG. 7, method 700 where the initial and second CSEM surveys are inverted 720 to produce an inversion result, which can include a detectable change in resistivity in the first zone). In some embodiments, determining the change in resistivity in the first zone includes determining a spatial distribution of resistivity in the first zone (922).

In some embodiments, method 900 includes receiving at the computing system a third electromagnetic survey measurement set acquired at the area of interest at a later time than the first electromagnetic survey measurement set, wherein the third electromagnetic survey measurement set includes a fifth resistivity value corresponding to the first zone and a sixth resistivity value corresponding to the second zone; and inverting the first and the third electromagnetic survey measurement sets to determine a change in resistivity in the first zone (924) (see e.g., FIG. 7, method 700 where a plurality of successive CSEM surveys are performed 712; one or more CSEM surveys in the plurality of successive CSEM surveys are inverted with the initial and second CSEM surveys 722).

In some embodiments, the second electromagnetic survey measurement set is inverted with the first and the third electromagnetic survey measurement sets to determine the change in resistivity in the first zone (926) (see e.g., FIG. 7, method 700 where one or more CSEM surveys in the plurality of successive CSEM surveys are inverted with the initial and second CSEM surveys 722). In some embodiments, four or more electromagnetic survey measurement sets are jointly inverted to determine the change in resistivity in the first zone.

In some embodiments, method 900 includes constraining resistivity in the second zone by setting the second, fourth, and sixth resistivity values to a constant value before inverting the first, second, and third electromagnetic survey measurement sets (928) (see e.g., FIG. 7, method 700 where respective resistivities for one or more non-reservoir zones are constrained 714 to be invariant)

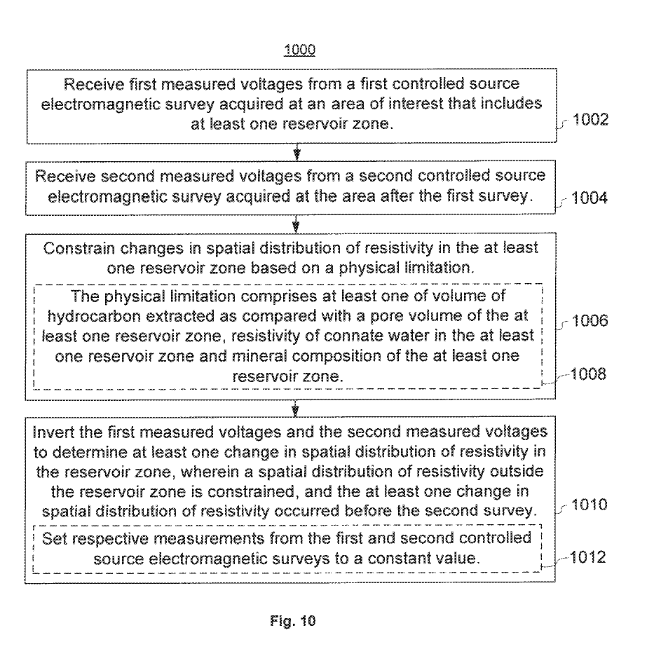

Attention is now directed to FIG. 10, which is a flow diagram illustrating an electromagnetic data processing method 1000 in accordance with some embodiments. Some operations in method 1000 may be combined and/or the order of some operations may be changed. Further, some operations in method 1000 may be combined with aspects of the example methods 700, 900, and/or 1100, and/or the order of some operations in method 1000 may be changed to account for incorporation of aspects of the example methods 700, 900, and/or 1100.

The method 1000 is performed at a computing device (e.g., computing system 100, FIG. 1).

Method 1000 includes receiving first measured voltages from a first controlled source electromagnetic survey acquired at an area of interest that includes at least one reservoir zone (1002) (see e.g., FIG. 7, method 700 where an initial CSEM survey is obtained 704, which can include a reservoir zone).

Method 1000 also includes receiving second measured voltages from a second controlled source electromagnetic survey acquired at the area after the first survey (1004) (see e.g., FIG. 7, method 700 where a second CSEM survey is obtained 710).

In some embodiments, method 1000 also includes constraining changes in spatial distribution of resistivity in the at least one reservoir zone based on a physical limitation (1006) (see e.g., FIG. 7, method 700 where respective resistivities are constrained for one or more reservoir zones based at least in part on physical limitations 716). In further embodiments, the physical limitation comprises at least one of volume of hydrocarbon extracted as compared with a pore volume of the at least one reservoir zone, resistivity of connate water in the at least one reservoir zone and mineral composition of the at least one reservoir zone (1008).

Method 1000 also includes inverting (1010) the first measured voltages and the second measured voltages to determine at least one change in spatial distribution of resistivity in the reservoir zone, wherein a spatial distribution of resistivity outside the reservoir zone is constrained, and the at least one change in spatial distribution of resistivity occurred before the second survey (see e.g., FIG. 7, method 700 where the initial and second CSEM surveys are inverted 720 to produce an inversion result, which can include a change in spatial distribution of resistivity in the reservoir zone; and respective resistivities for one or more non-reservoir zones are constrained to be invariant 714).

In some embodiments, constraining the spatial distribution of resistivity outside the reservoir zone includes setting respective measurements from the first and second controlled source electromagnetic surveys to a constant value (1012) (see e.g., FIG. 7, method 700 where respective resistivities for one or more non-reservoir zones are constrained to be invariant 714).

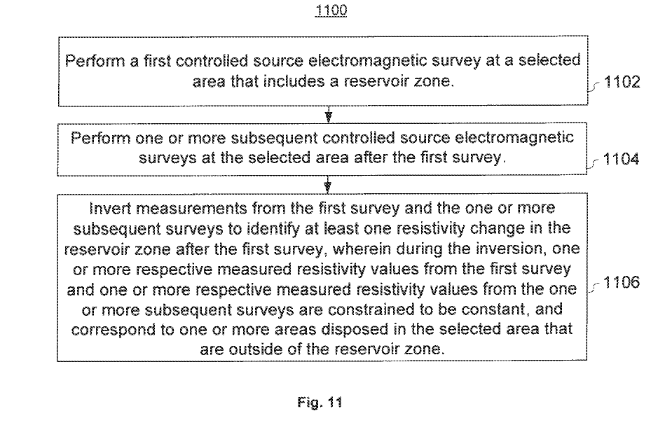

Attention is now directed to FIG. 11, which is a flow diagram illustrating an electromagnetic data processing method 1100 in accordance with some embodiments. Some operations in method 1100 may be combined and/or the order of some operations may be changed. Further, some operations in method 1100 may be combined with aspects of the example methods 700, 900, and/or 1000, and/or the order of some operations in method 1100 may be changed to account for incorporation of aspects of the example methods 700, 900, and/or 1000.

The method 1100 is performed at least in part at a computing device (e.g., computing system 100, FIG. 1).

Method 1100 includes performing a first controlled source electromagnetic survey at a selected area that includes a reservoir zone (1102), and performing one or more subsequent controlled source electromagnetic surveys at the selected area after the first survey (1104).

Method 1100 also includes inverting (1106) measurements from the first survey and the one or more subsequent surveys to identify at least one resistivity change in the reservoir zone after the first survey, wherein during the inversion, one or more respective measured resistivity values from the first survey and one or more respective measured resistivity values from the one or more subsequent surveys are constrained to be constant, and correspond to one or more areas disposed in the selected area that are outside of the reservoir zone (see e.g., FIG. 7, method 700 where the initial and second CSEM surveys are inverted 720; respective resistivities for one or more non-reservoir zones are constrained to be invariant 714).

The steps in the processing methods described above may be implemented by running one or more functional modules in information processing apparatus such as general purpose processors or application specific chips, such as ASICs, FPGAs, PLDs, or other appropriate devices. These modules, combinations of these modules, and/or their combination with general hardware are all included within the scope of protection of the invention.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A method, comprising:
receiving at a computing system a first electromagnetic survey measurement set acquired at an area of interest at a first time, wherein:
the area of interest includes at least a first zone and a second zone, and
the first electromagnetic survey measurement set includes:
a first resistivity value corresponding to the first zone, and
a second resistivity value corresponding to the second zone;
receiving at the computing system a second electromagnetic survey measurement set acquired at the area of interest after the first time, wherein the second electromagnetic survey measurement set includes:
a third resistivity value corresponding to the first zone, and
a fourth resistivity value corresponding to the second zone;
constraining the second and fourth resistivity values; and
inverting the first and the second electromagnetic survey measurement sets to determine a change in resistivity in the first zone.

2. The method of claim 1, wherein a hydrocarbon reservoir is disposed in the first zone.

3. The method of claim 1, wherein determining the change in resistivity in the first zone includes determining a spatial distribution of resistivity in the first zone.

4. The method of claim 1, further comprising receiving at the computing system an initial structural model of the area of interest, wherein the initial structural model is based on a seismic survey.

5. The method of claim 4, further comprising constraining one or more subareas of the area of interest based on the initial structural model before inverting the first and the second electromagnetic survey measurement sets.

6. The method of claim 1, wherein constraining the second and fourth resistivity values includes setting the second and fourth resistivity values to a constant value.

7. The method of claim 1, further comprising constraining changes in spatial distribution of resistivity in the first zone based on a physical limitation.

8. The method of claim 6, wherein the physical limitation is selected from the group of metrics consisting of a volume of hydrocarbon extracted as compared with a pore volume of the first zone, resistivity of connate water in the first zone, and mineral composition of the first zone.

9. The method of claim 1, further comprising:
receiving at the computing system a third electromagnetic survey measurement set acquired at the area of interest at a later time than the first electromagnetic survey measurement set, wherein the third electromagnetic survey measurement set includes a fifth resistivity value corresponding to the first zone and a sixth resistivity value corresponding to the second zone; and
inverting the first and the third electromagnetic survey measurement sets to determine a change in resistivity in the first zone.

10. The method of claim 8, further comprising inverting the second electromagnetic survey measurement set with the first and the third electromagnetic survey measurement sets to determine the change in resistivity in the first zone.

11. The method of claim 9, further comprising constraining resistivity in the second zone by setting the second, fourth, and sixth resistivity values to a constant value before inverting the first, second, and third electromagnetic survey measurement sets.

12. A computing system for determining at least one change in spatial distribution of electrical resistivity in an area of interest that includes at least one reservoir zone, the system comprising:
at least one processor;
at least one non-transitory memory; and
one or more programs stored in the at least one non-transitory memory, wherein the one or more programs are configured to be executed by the one or more processors, the one or more programs including instructions for:
accepting as input first measured voltages from a first controlled source electromagnetic survey acquired at the area;
accepting as input second measured voltages from a second controlled source electromagnetic survey acquired at the area after the first survey; and
inverting the first measured voltages and the second measured voltages to determine at least one change in spatial distribution of resistivity in the reservoir zone, wherein:
a spatial distribution of resistivity outside the reservoir zone is constrained, and
the at least one change in spatial distribution of resistivity occurred before the second survey.

13. The computing system of claim 12, wherein constraining the spatial distribution of resistivity outside the reservoir zone includes setting respective measurements from the first and second controlled source electromagnetic surveys to a constant value.

14. The computing system of claim 12, further comprising constraining changes in spatial distribution of resistivity in the at least one reservoir zone based on a physical limitation.

15. The computing system of claim 14, wherein the physical limitation comprises at least one of volume of hydrocarbon extracted as compared with a pore volume of the at least one reservoir zone, resistivity of connate water in the at least one reservoir zone and mineral composition of the at least one reservoir zone.

16. A method, comprising:
performing a first controlled source electromagnetic survey at a selected area that includes a reservoir zone;
performing one or more subsequent controlled source electromagnetic surveys at the selected area after the first survey; and
inverting measurements from the first survey and the one or more subsequent surveys to identify at least one resistivity change in the reservoir zone after the first survey,
wherein during the inversion, one or more respective measured resistivity values from the first survey and one or more respective measured resistivity values from the one or more subsequent surveys:
are constrained to be constant, and
correspond to one or more areas disposed in the selected area that are outside of the reservoir zone.
